(19) United States
(12) Patent Application Publication
(10) Pub. No.: US 2026/0309637 A1
(43) Pub. Date: Oct. 8, 2026

(54) DARK FIELD DEFECT INSPECTION SYSTEM AND INSPECTION METHOD THEREOF

(71) Applicant: Samsung Electronics Co., Ltd., Suwon-si (KR)

(72) Inventors: Seongkeun Cho, Suwon-si (KR); Taehyun Kim, Suwon-si (KR); Hyungu Kim, Suwon-si (KR); Sangwoo Bae, Suwon-si (KR); Akinori Okubo, Suwon-si (KR); Seulgi Lee, Suwon-si (KR); Janghwi Lee, Suwon-si (KR); Jungchul Lee, Suwon-si (KR)

(73) Assignee: Samsung Electronics Co., Ltd., Suwon-si (KR)

(21) Appl. No.: 19/391,199

(22) Filed: Nov. 17, 2025

(30) Foreign Application Priority Data
Apr. 3, 2025 (KR) 10-2025-0043608

(51) Int. Cl. G01N 21/88; G01N 21/21; G01N 21/956

(52) U.S. Cl. CPC G01N 21/8806; G01N 21/211; G01N 21/956; G01N 2021/8822; G01N 2021/8848; G01N 2201/0683

(57) ABSTRACT

A dark field defect inspection system includes a stage on which an inspection substrate is arranged, an illumination optical system radiating incident light to a top surface of the inspection substrate and arranged along a first oblique optical axis rotated in a first rotation direction from a normal line to the top surface of the inspection substrate, a calibration optical system receiving calibration light and arranged along a second oblique optical axis rotated in a second rotation direction opposite to the first rotation direction from the normal line, and an inspection optical system receiving inspection light and arranged along a vertical optical axis extending upward from the inspection substrate. The inspection optical system includes an inspection analyzer arranged after the objective lens along the vertical optical axis and an aperture arranged along the vertical optical axis and arranged in an exit pupil plane of the objective lens.

### CROSS-REFERENCE TO RELATED APPLICATIONS

This present application claims priority to and the benefit under 35 U.S.C. § 119 (a)-(d) of Korean Patent Application No. 10-2025-0043608, filed on Apr. 3, 2025, in the Korean Intellectual Property Office, the entire disclosure of which is incorporated herein by reference.

### BACKGROUND

The disclosed concepts relate to a dark field defect inspection system and an inspection method, and more particularly, to a system and method for inspecting a defect based on null-ellipsometry.

In general, ellipsometry is a method of deriving the surface characteristics of a substrate by analyzing a change in polarization of light reflected or scattered from the substrate. Optical systems based on null-ellipsometry may be designed such that reflected and scattered light from the surface of a substrate is not detected by analyzing a change in polarization. Accordingly, optical systems based on null-ellipsometry may generate a dark field image in which only scattered light from a defect in the substrate is detected.

### SUMMARY

The disclosed concepts provide a dark field defect inspection system capable of accurately detecting a defect in a top surface of a substrate.

The problems to be solved by the present disclosure are not limited to the problems mentioned above, and other problems can be clearly understood by those skilled in the art from the description below.

According to aspects of the disclosed concepts, there is provided a dark field defect inspection system including a stage on which an inspection substrate is arranged, an illumination optical system configured to radiate incident light to a top surface of the inspection substrate and arranged along a first oblique optical axis rotated in a first rotation direction from a normal line to the top surface of the inspection substrate by an oblique angle, a calibration optical system configured to receive calibration light and arranged along a second oblique optical axis rotated in a second rotation direction from the normal line by the oblique angle, the second rotation direction being opposite to the first rotation direction, and an inspection optical system configured to receive inspection light and arranged along a vertical optical axis extending upward from the inspection substrate, wherein the illumination optical system includes a light source configured to output the incident light, a delivery optical system configured to shape the incident light output from the light source into a preset shape, the delivery optical system including at least one lens, a first phase retardation plate and a second phase retardation plate each configured to delay a phase of the incident light, and a linear polarizer arranged between the first phase retardation plate and the second phase retardation plate, the inspection optical system includes an inspection detector configured to receive the inspection light, an objective lens facing an inspection region of the inspection substrate, a tube lens arranged before the inspection detector along the vertical optical axis, an inspection analyzer arranged after the objective lens along the vertical optical axis, and an aperture arranged along the vertical optical axis and arranged in an exit pupil plane of the objective lens, the delivery optical system of the illumination optical system includes a cylindrical lens arranged between the first phase retardation plate and the light source along the first oblique optical axis, the exit pupil plane of the objective lens includes a virtual plane on which the inspection light exiting the objective lens converges, the oblique angle is about 50 degrees to about 75 degrees, and the calibration light and the inspection light include scattered light from the inspection substrate.

According to aspects of the disclosed concepts, there is provided a dark field defect inspection system including a stage, an illumination optical system configured to radiate incident light to a top surface of an inspection substrate along a first oblique optical axis rotated in a first rotation direction from a normal line to the top surface of the inspection substrate by an oblique angle, a calibration optical system configured to receive calibration light traveling along a second oblique optical axis rotated in a second rotation direction from the normal line by the oblique angle, the second rotation direction being opposite to the first rotation direction, and an inspection optical system configured to receive inspection light traveling along a vertical optical axis extending upward from the inspection substrate, wherein the illumination optical system includes a light source configured to output the incident light, a half-wave plate arranged after the light source along the first oblique optical axis, a linear polarizer arranged after the half-wave plate along the first oblique optical axis, and a quarter-wave plate arranged after the linear polarizer along the first oblique optical axis, the inspection optical system includes an inspection detector configured to receive the inspection light, an objective lens facing an inspection region of the inspection substrate, a tube lens arranged before the inspection detector along the vertical optical axis, an inspection analyzer arranged along the vertical optical axis and arranged in a first exit pupil plane of the objective lens, and an aperture arranged along the vertical optical axis and arranged in a second exit pupil plane of the objective lens, and the first exit pupil plane and the second exit pupil plane each include a virtual plane on which the inspection light exiting the objective lens converges.

According to aspects of the disclosed concepts, there is provided a dark field defect inspection system including a stage on which an inspection substrate is arranged, an illumination optical system configured to radiate incident light to a top surface of the inspection substrate along a first oblique optical axis rotated in a first rotation direction from a normal line to the top surface of the inspection substrate by an oblique angle, a calibration optical system configured to receive calibration light traveling along a second oblique optical axis rotated in a second rotation direction from the normal line by the oblique angle, the second rotation direction being opposite to the first rotation direction, and an inspection optical system configured to receive inspection light traveling along a vertical optical axis from the inspection substrate, wherein the illumination optical system includes a light source configured to output the incident light, a first phase retardation plate and a second phase retardation plate each arranged along the first oblique optical axis and configured to delay a phase of the incident light, and a linear polarizer arranged between the first phase retardation plate and the second phase retardation plate along the first oblique optical axis, the inspection optical system includes an inspection detector configured to receive the inspection light, an objective lens arranged along the vertical optical axis and facing an inspection region of the inspection substrate, a tube lens arranged before the inspection detector along the vertical optical axis, a first relay lens and a second relay lens arranged between the objective lens and the tube lens along the vertical optical axis, an inspection analyzer arranged between the first relay lens and the second relay lens along the vertical optical axis, and an aperture arranged before the tube lens along the vertical optical axis, the inspection analyzer is arranged in a rear focal plane of the first relay lens and a front focal plane of the second relay lens, the aperture is arranged in a rear focal plane of the second relay lens and a front focal plane of the tube lens, the oblique angle is about 50 degrees to about 75 degrees, and the calibration light and the inspection light include scattered light from the inspection substrate.

According to aspects of the disclosed concepts, there is provided a defect inspection method of a dark field defect inspection system. The defect inspection method includes performing at least three calibration imaging processes of a sample substrate when the sample substrate is fed into the dark field defect inspection system, identifying an estimated inspection angle of an inspection analyzer, based on the at least three calibration imaging processes, identifying an optimized inspection angle of the inspection analyzer based on a plurality of first inspection imaging processes of the sample substrate and the estimated inspection angle, identifying an optimized location and an optimized size of a transmitting portion of an aperture based on a plurality of second inspection imaging processes of the sample substrate, obtaining an inspection image of an inspection substrate when the inspection substrate is fed into the dark field defect inspection system, and identifying whether there is a defect of interest based on the inspection image of the inspection substrate, wherein the obtaining of the inspection image of the inspection substrate includes changing an azimuth angle of the inspection analyzer to the optimized inspection angle, changing a location of the transmitting portion of the aperture to the optimized location, changing a size of the transmitting portion of the aperture to the optimized size, and obtaining the inspection image through an inspection detector, the sample substrate has the same structure as the inspection substrate, and the defect of interest is in a top surface of the sample substrate.

In some embodiments, the identifying of the optimized inspection angle of the inspection analyzer may include changing the azimuth angle of the inspection analyzer within a fine tuning range, obtaining, from the inspection detector, a plurality of angle-optimization images respectively corresponding to a plurality of azimuth angles of the inspection analyzer, identifying an image having a minimum signal intensity among the plurality of angle-optimization images, and identifying, as an optimized inspection angle, the azimuth angle of the inspection analyzer that corresponds to the image having the minimum signal intensity. The fine tuning range may be determined based on the estimated inspection angle.

In some embodiments, the identifying of the optimized inspection angle of the inspection analyzer may include changing the azimuth angle of the inspection analyzer to the estimated inspection angle, obtaining, from the inspection detector, a reference image of the sample substrate at the estimated inspection angle, obtaining a first image of the sample substrate from the inspection detector by changing the azimuth angle of the inspection analyzer from the estimated inspection angle by a minute change angle, and identifying a fine-tuning direction by comparing a signal intensity of the reference image with a signal intensity of the first image.

In some embodiments, the identifying of the optimized location and the optimized size of the transmitting portion may include scanning the location of the transmitting portion along an exit pupil plane of the objective lens, obtaining, from the inspection detector, a plurality of location-optimization images respectively corresponding to a plurality of locations of the transmitting portion, identifying an image having a maximum signal-to-noise ratio (SNR) among the plurality of location-optimization images, and identifying, as the optimized location, the location of the transmitting portion that corresponds to the image having the maximum SNR.

In some embodiments, the identifying of the optimized location and the optimized size of the transmitting portion may include changing the size of the transmitting portion in the exit pupil plane, obtaining, from the inspection detector, a plurality of size-optimization images respectively corresponding to a plurality of sizes of the transmitting portion, identifying an image having a maximum SNR among the plurality of size-optimization images, and identifying, as the optimized size, the size of the transmitting portion that corresponds to the image having the maximum SNR.

In some embodiments, the defect of interest may include a protrusion-type defect. The changing of the size of the transmitting portion may include changing the size of the transmitting portion between a first size and a second size. The first size may be the size of the transmitting portion that allows a numerical aperture of an inspection optical system to be 0.5, and the second size may be the size of the transmitting portion that allows the numerical aperture of the inspection optical system to be 0.7.

In some embodiments, the defect of interest may include a protrusion-type defect. The scanning of the location of the transmitting portion along the exit pupil plane of the objective lens may include scanning the location of the transmitting portion along a scanning region of the exit pupil plane. The scanning region may be within a quarter of a radius of the exit pupil plane from a center of the exit pupil plane.

In some embodiments, the identifying of the estimated inspection angle may include identifying an ellipsometric parameter based on the at least three calibration imaging processes through a calibration optical system and identifying the estimated inspection angle based on the ellipsometric parameter and a light incident angle of an illumination optical system to the sample substrate.

In some embodiments, the estimated inspection angle may be identified based on est. A2=tan⁻¹ (tan ψ/cos θ), the ψ may be the ellipsometric parameter, and θ may be the light incident angle.

In some embodiments, the obtaining of the inspection image of the inspection substrate may further include changing a location of a tube lens to set a magnification of the inspection optical system to about 50 times to about 300 times.

### BRIEF DESCRIPTION OF THE DRAWINGS

Embodiments will be more clearly understood from the following detailed description taken in conjunction with the accompanying drawings in which:

FIG. 1 is a cross-sectional view of a dark field defect inspection system according to embodiments;

FIG. 2 is a flowchart of a method of inspecting a dark field defect, according to embodiments;

FIG. 3 is a flowchart of a method of optimizing an inspection analyzer, according to embodiments;

FIG. 4 is a cross-sectional view illustrating an azimuth angle of an inspection analyzer, according to embodiments;

FIG. 5A is a graph illustrating a method of optimizing an inspection analyzer, according to embodiments;

FIG. 5B is a graph illustrating a method of optimizing an inspection analyzer, according to embodiments;

FIG. 6 is a flowchart of a method of optimizing an aperture, according to embodiments;

FIG. 7A is a plan view of an aperture according to embodiments;

FIG. 7B is a plan view of an aperture according to embodiments;

FIG. 7C is a table illustrating a method of optimizing a transmitting portion of an aperture, according to embodiments;

FIG. 8 is a cross-sectional view of a sample substrate according to embodiments;

FIG. 9A is a schematic graph showing experimental results of a dark field defect inspection system, according to embodiments;

FIG. 9B is a schematic graph showing experimental results of a dark field defect inspection system, according to embodiments;

FIG. 9C is a schematic graph showing experimental results of a dark field defect inspection system, according to embodiments;

FIG. 10 is a diagram illustrating a configuration of an illumination optical system according to embodiments;

FIGS. 11A to 11C show defect inspection images obtained by a dark field defect inspection system, according to embodiments; and

FIG. 12 is a schematic graph showing experimental results of a dark field defect inspection system, according to embodiments.

### DETAILED DESCRIPTION

Hereinafter, embodiments will be described in detail with reference to the accompanying drawing. In the drawing, like reference characters denote like elements, and redundant descriptions thereof will be omitted.

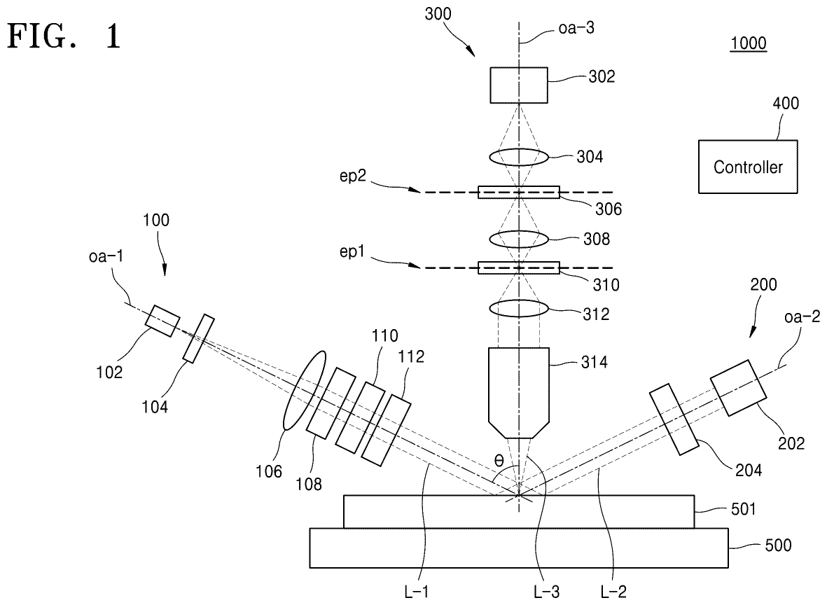

FIG. 1 is a cross-sectional view of a dark field defect inspection system 1000 according to embodiments.

Referring to FIG. 1, the dark field defect inspection system 1000 may include an illumination optical system 100, a calibration optical system 200, an inspection optical system 300, a controller 400, and a stage 500.

Here, incident light L-1 may travel along a first oblique optical axis oa-1 and may refer to light that the illumination optical system 100 radiates to the top surface of an inspection substrate 501. Calibration light L-2 may travel along a second oblique optical axis oa-2 and may refer to light received by the calibration optical system 200. Inspection light L-3 may travel along a vertical optical axis oa-3 and may refer to light received by the inspection optical system 300. The calibration light L-2 and the inspection light L-3 may include scattered light from the top surface of the inspection substrate 501.

The illumination optical system 100 may radiate the incident light L-1 to the top surface of the inspection substrate 501. The illumination optical system 100 may include a light source 102, a beam attenuator 104, a delivery optical system 106, a first phase retardation plate 108, a linear polarizer 110, and a second phase retardation plate 112. The illumination optical system 100 may further include other elements in addition to the elements described above. Some of the elements described above may be omitted from the illumination optical system 100. The illumination optical system 100 may be arranged on the first oblique optical axis oa-1. Specifically, as shown in FIG. 1, the light source 102, the beam attenuator 104, the delivery optical system 106, the first phase retardation plate 108, the linear polarizer 110, and the second phase retardation plate 112 may be sequentially arranged along the first oblique optical axis oa-1.

Here, the first oblique optical axis oa-1 may be an optical axis that is rotated in a first rotation direction from a normal line to the top surface of the inspection substrate 501 by an oblique angle θ. For example, the oblique angle θ may be about 50 degrees to about 75 degrees.

The light source 102 may output the incident light L-1. The light source 102 may include a single-wavelength light source or a multi-wavelength light source. In some embodiments, the wavelength of the incident light L-1 output from the light source 102 may include at least one of about 266 nm and about 355 nm.

The beam attenuator 104 may be arranged after the light source 102 along the first oblique optical axis oa-1. The beam attenuator 104 may attenuate a beam so that energy of the incident light L-1 reaching the delivery optical system 106 may be adjusted and controlled.

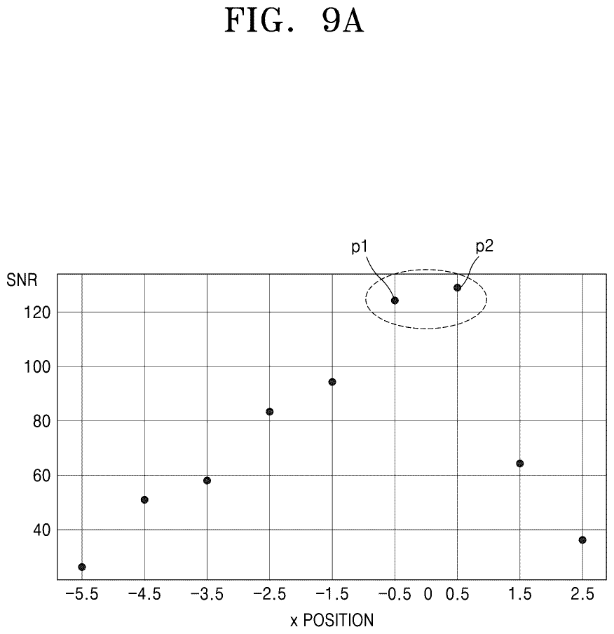

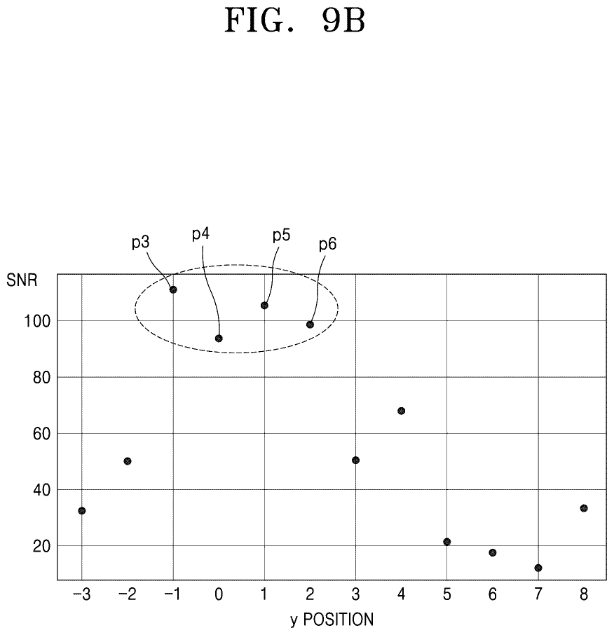

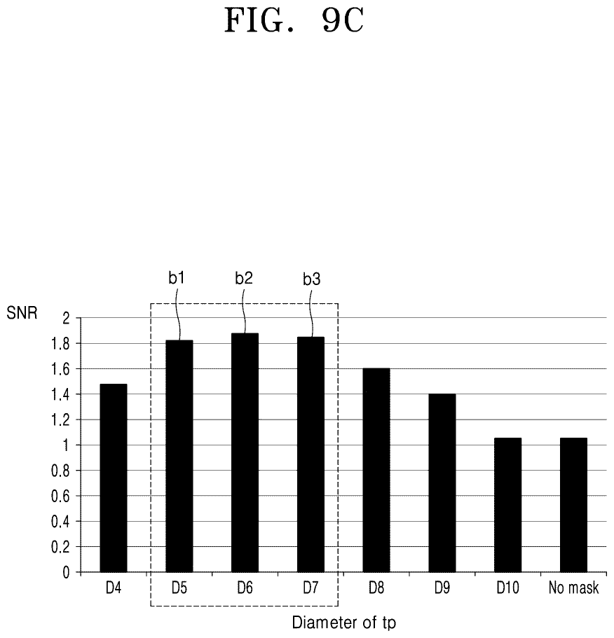

The delivery optical system 106 may be arranged after the light source 102 and the beam attenuator 104 along the first oblique optical axis oa-1. The delivery optical system 106 may adjust the direction of the incident light L-1 or shape or adjust the shape of a cross-section of the incident light L-1 such that the incident light L-1 may be incident to the top surface of the inspection substrate 501 in a desired shape. In some embodiments, the delivery optical system 106 may collimate the incident light L-1. In some embodiments, the delivery optical system 106 may include a cylindrical lens to collimate the incident light L-1 in a first direction and transmit the incident light L-1 as is in a second direction perpendicular to the first direction. Embodiments in which the delivery optical system 106 includes a cylindrical lens is described in detail below with reference to FIGS. 9A to 9C.

The first phase retardation plate 108 and the second phase retardation plate 112 may be arranged after the delivery optical system 106 along the first oblique optical axis oa-1. The first phase retardation plate 108 and the second phase retardation plate 112 may change the incident light L-1 from a linear polarization state to a circular polarization state or an elliptical polarization state.

The linear polarizer 110 may be arranged between the first phase retardation plate 108 and the second phase retardation plate 112 along the first oblique optical axis oa-1. The linear polarizer 110 may change the polarization state of the incident light L-1 to the linear polarization state. For example, the linear polarizer 110 may pass only a p-polarization component or an s-polarization component. In some embodiments, the first phase retardation plate 108 may correspond to a half-wave plate, and the second phase retardation plate 112 may correspond to a quarter-wave plate.

The calibration optical system 200 may receive the calibration light L-2 from the top surface of the inspection substrate 501. The calibration optical system 200 may calculate a first ellipsometric parameter, v, and a second ellipsometric parameter, A For this calculation, the calibration optical system 200 may include a calibration detector 202 and a calibration analyzer 204. The calibration optical system 200 may further include other elements in addition to the elements described above. Some of the elements described above may be omitted from the calibration optical system 200. The calibration optical system 200 may be arranged on the second oblique optical axis oa-2. Specifically, as shown in FIG. 1, the calibration detector 202 and the calibration analyzer 204 may be sequentially arranged along the second oblique optical axis oa-2.

Here, the second oblique optical axis oa-2 may be an optical axis that is rotated in a second rotation direction from the normal line to the top surface of the inspection substrate 501 by the oblique angle θ. Here, the second rotation direction may be opposite to the first rotation direction in which the first oblique optical axis oa-1 is rotated from the normal line. For example, as shown in FIG. 1, when the first rotation direction is counterclockwise, the second rotation direction may be clockwise.

The calibration detector 202 may be arranged after the calibration analyzer 204 along the second oblique optical axis oa-2. The calibration detector 202 may receive the calibration light L-2 output from the calibration analyzer 204 and may generate a two-dimensional (2D) image of the inspection substrate 501. For example, the calibration detector 202 may include a photodiode (PD) sensor.

The calibration analyzer 204 may be arranged before the calibration detector 202 along the second oblique optical axis oa-2. The calibration analyzer 204 may receive the calibration light L-2 and output the calibration light L-2 in the linear polarization state. In other words, the calibration analyzer 204 may correspond to a polarizer that may selectively pass only a specific linear polarization component.

The inspection optical system 300 may receive the inspection light L-3 from the top surface of the inspection substrate 501. The inspection optical system 300 may be designed to generate a dark field image for inspecting whether there is a defect in the top surface of the inspection substrate 501. For this operation, the inspection optical system 300 may include an inspection detector 302, a tube lens 304, an aperture 306, a first relay lens 312, a second relay lens 308, an inspection analyzer 310, and an objective lens 314. The inspection optical system 300 may further include other elements in addition to the elements described above. Some of the elements described above may be omitted from the inspection optical system 300. The inspection optical system 300 may be arranged on the vertical optical axis oa-3. Specifically, as shown in FIG. 1, the inspection detector 302, the tube lens 304, the aperture 306, the second relay lens 308, the inspection analyzer 310, the first relay lens 312, and the objective lens 314 may be sequentially arranged along the vertical optical axis oa-3.

At least a portion of the vertical optical axis oa-3 may be parallel with the normal line to the top surface of the inspection substrate 501. In some embodiments, the vertical optical axis oa-3 may be parallel with the normal line to the top surface of the inspection substrate 501. In some embodiments, the inspection optical system 300 may include at least one mirror that changes the traveling direction of the inspection light L-3. In this case, a portion of the vertical optical axis oa-3 may not be parallel with the normal line to the top surface of the inspection substrate 501.

The inspection detector 302 may be arranged after the tube lens 304 along the vertical optical axis oa-3. The inspection detector 302 may receive the inspection light L-3 from the tube lens 304 and may generate a 2D image of the inspection substrate 501. The inspection detector 302 may include a high-sensitivity detector that may detect a very weak scatted light signal under a null condition. For example, the inspection detector 302 may include an electron multiplying charge-coupled device (EMCCD) or a scientific complementary metal-oxide semiconductor (sCMOS) device.

The tube lens 304 may be arranged before the inspection detector 302 along the vertical optical axis oa-3. The tube lens 304 may focus the inspection light L-3 such that a 2D image may be formed on an image plane of the inspection detector 302.

The tube lens 304 may be driven along the vertical optical axis oa-3. In this case, the magnification of the inspection optical system 300 may be changed based on the driving of the tube lens 304 along the vertical optical axis oa-3. According to embodiments, the inspection optical system 300 may further include a magnification adjustment device (not shown), which drives the tube lens 304 along the vertical optical axis oa-3. The magnification adjustment device may be connected to the tube lens 304. In some embodiments, the magnification of the inspection optical system 300 may be about 50 times to about 300 times.

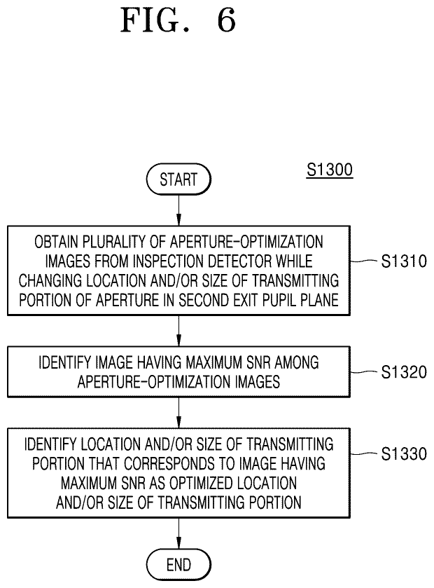

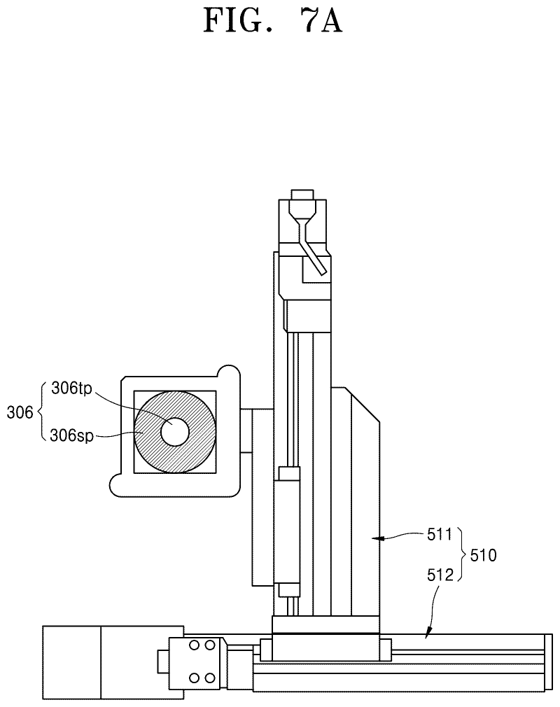

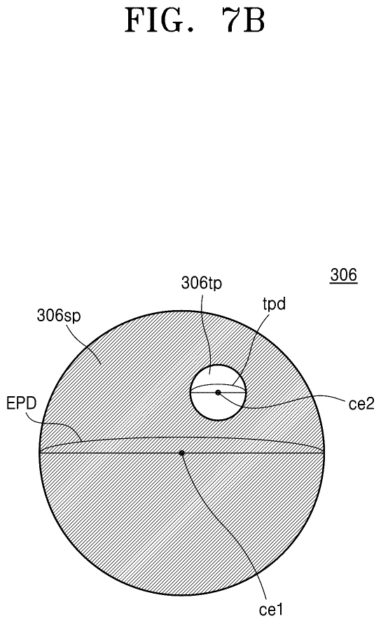

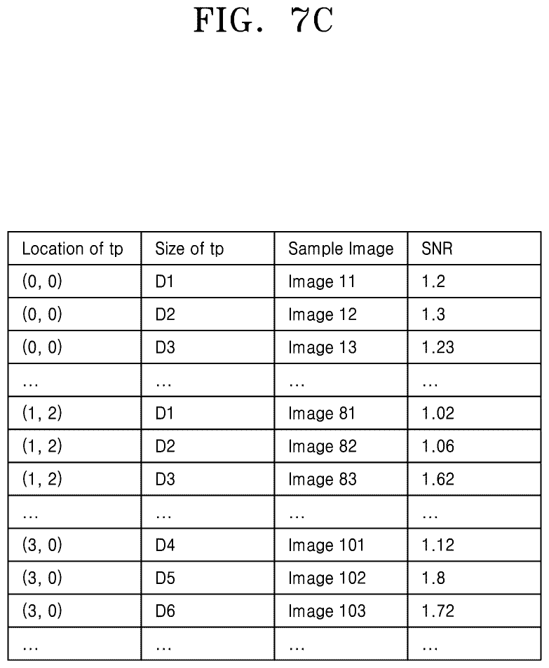

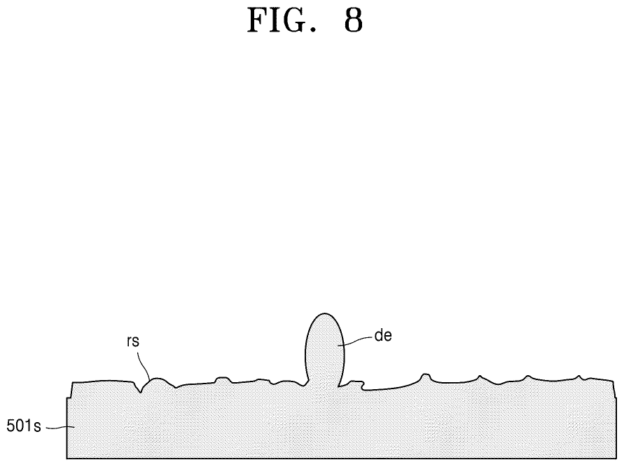

The aperture 306 may be arranged before the tube lens 304 and after the second relay lens 308 along the vertical optical axis oa-3. The aperture 306 may include a transmitting portion and a shielding portion surrounding the transmitting portion. A portion of the inspection light L-3 may travel to the tube lens 304 through the transmitting portion of the aperture 306, and the other portion of the inspection light L-3 may be shield by the shielding portion of the aperture 306. The transmitting portion of the aperture 306 may be positioned at an optimized location and may have an optimized size for detection of a defect of interest. This will be described in detail with reference to FIG. 6, FIG. 7A, FIG. 7B, FIG. 7C, FIG. 8, FIG. 9A, FIG. 9B, and FIG. 9C.

The first relay lens 312 and the second relay lens 308 may be arranged after the objective lens 314 along the vertical optical axis oa-3. The first relay lens 312 and the second relay lens 308 may respectively form, outside the objective lens 314, a first exit pupil plane ep1 and a second exit pupil plane ep2 of the objective lens 314.

Each of the first exit pupil plane ep1 and the second exit pupil plane ep2 may be an exit pupil plane of the objective lens 314 and may refer to a virtual plane on which the inspection light L-3 exiting the objective lens 314 converges. Here, the expression “the inspection light L-3 converges” may include not only the case where multiple rays included in the inspection light L-3 converge on one point but also the case where multiple rays converge at narrow intervals. In this case, the first exit pupil plane ep1 may be located closer to the inspection substrate 501 than the second exit pupil plane ep2.

In some embodiments, the first exit pupil plane ep1 may be a rear focal plane of the first relay lens 312 and a front focal plane of the second relay lens 308. The second exit pupil plane ep2 may be a rear focal plane of the second relay lens 308 and a front focal plane of the tube lens 304.

The objective lens 314 may be arranged before the first relay lens 312 along the vertical optical axis oa-3. The objective lens 314 may be arranged to face an inspection region of the inspection substrate 501. The inspection region may be a portion of an illumination region. In other words, the illumination region of the inspection substrate 501 illuminated by the incident light L-1 may be wider than the inspection region of the inspection substrate 501 focused by the objective lens 314.

A numerical aperture (NA) of the inspection optical system 300 may be determined according to the objective lens 314. For example, the NA of the inspection optical system 300 may be 0.8 according to the design and the placement of the objective lens 314 The NA of the inspection optical system 300 may vary with the placement and the design of the aperture 306, which will be described in detail with reference to FIG. 6, FIG. 7A, FIG. 7B, FIG. 7C, FIG. 8, FIG. 9A, FIG. 9B, and FIG. 9C.

The controller 400 may be operatively connected with the illumination optical system 100, the calibration optical system 200, the inspection optical system 300, and the stage 500 and may generally control operations of the dark field defect inspection system 1000. The controller 400 may be implemented by hardware, firmware, software, or a combination thereof. For example, the controller 400 may include a processor and a memory. For example, the controller 400 may include a computing device, such as a workstation computer, a desktop computer, a laptop computer, or a tablet computer. The controller 400 may include a complex processor, such as a microprocessor, a central processing unit (CPU), or a graphics processing unit (GPU), a processor configured by software, dedicated hardware, or firmware. For example, the controller 400 may be implemented by a general-use computer or an application-specific hardware component, such as a digital signal processor (DSP), a field programmable gate array (FPGA), or an application-specific integrated circuit (ASIC). The controller 400 may be embodied as instructions, which are stored in a machine-readable medium and may be read and executed by at least one processor. Here, the machine-readable medium may include a mechanism for storing and/or transmitting information in a form readable by a machine (e.g., a computing device). Examples of the machine-readable medium may include read-only memory (ROM), random access memory (RAM), magnetic disk storage media, optical storage media, flash memory devices, electrical, optical or acoustic or other types of wave signals (e.g., carriers, infrared signals, digital signals, etc.), and other signals.

According to embodiments, the controller 400 may control an azimuth angle of the linear polarizer 110, an azimuth angle of the calibration analyzer 204, and an azimuth angle of the inspection analyzer 310. Specifically, the azimuth angle of each of the linear polarizer 110, the calibration analyzer 204, and the inspection analyzer 310 may refer to an angle by which the polarization axis of each of the linear polarizer 110, the calibration analyzer 204, and the inspection analyzer 310 is rotated with respect to a reference direction (e.g., the direction of the p-polarization component). In a specific example, the inspection optical system 300 may include a rotary device (not shown), which changes the azimuth angle of the inspection analyzer 310, and the controller 400 may control the rotary device to change the azimuth angle of the inspection analyzer 310.

In some embodiments, the calibration analyzer 204 and the inspection analyzer 310 may each be implemented with a polarizing optical element such as a linear polarizer. Specifically, each of the calibration analyzer 204 and the inspection analyzer 310 may be implemented with a Glan-Thompson and Glan-Taylor polarizer having a high extinction ratio and may perform precise polarization control.

The controller 400 may obtain an image of the inspection substrate 501 from the calibration detector 202 and/or the inspection detector 302. For convenience of description, an image obtained from the calibration detector 202 is referred to as a “calibration image” or an image obtained through “calibration imaging.” An image obtained from the inspection detector 302 is referred to as an “inspection image” or an image obtained through “inspection imaging.”

The stage 500 may support and fix the inspection substrate 501. The inspection substrate 501 may be arranged on the top surface of the stage 500. The stage 500 may move in a horizontal direction and a vertical direction. The stage 500 may move the inspection substrate 501 so that calibration imaging and inspection imaging may be performed on a desired portion of the inspection substrate 501. The inspection substrate 501 may correspond to any one of various types of devices, such as a wafer, a semiconductor package, a semiconductor chip, and a display panel. According to embodiments, in the dark field defect inspection system 1000, the inspection substrate 501 may correspond to a wafer. The wafer may be a wafer with a periodic pattern formed on the top surface thereof or a bare wafer with no pattern. Alternatively, a sample substrate (e.g., a sample wafer) may be arranged on the stage 500. The sample substrate may be used to obtain optimized conditions for the dark field defect inspection system 1000. The optimized conditions are described in detail in the description of the drawings below.

According to embodiments, the inspection analyzer 310 of the inspection optical system 300 may be arranged in the first exit pupil plane ep1, and the aperture 306 may be arranged in the second exit pupil plane ep2. As the aperture 306 is arranged in the second exit pupil plane ep2, the dark field defect inspection system 1000 may obtain an image with a high signal-to-noise ratio (SNR).

Specifically, an image to be obtained by the dark field defect inspection system 1000 may be a dark field image, and the inspection optical system 300 may be designed such that surface-scattered light from the top surface of the inspection substrate 501 is blocked from reaching the inspection detector 302 and only defect-scattered light from a defect in the inspection substrate 501 is detected by the inspection detector 302. The top surface of the inspection substrate 501 may be rough. Surface-scattered light from a rough surface may not be completely blocked by the inspection analyzer 310 set to the azimuth angle of the null condition. In theory, the inspection analyzer 310 set to the null condition is supposed to completely block the surface-scattered light. However, in practice, part of the surface-scattered light may not be blocked by the inspection analyzer 310 set to the null condition. As described above, the part of surface-scattered light that is not blocked by the inspection analyzer 310 may be detected as “noise” during inspection imaging.

As the aperture 306 optimized to correspond to a defect of interest is arranged in the second exit pupil plane ep2, noise as described above may be blocked by the aperture 306. Accordingly, the dark field defect inspection system 1000 may obtain a dark field image with a high SNR and accurately and quickly inspect whether there is a defect of interest in the inspection substrate 501. The dark field defect inspection system 1000 may also effectively receive scattered light from a defect by including the inspection optical system 300 arranged on the vertical optical axis oa-3.

FIG. 1 is referred to for all descriptions of the drawings below.

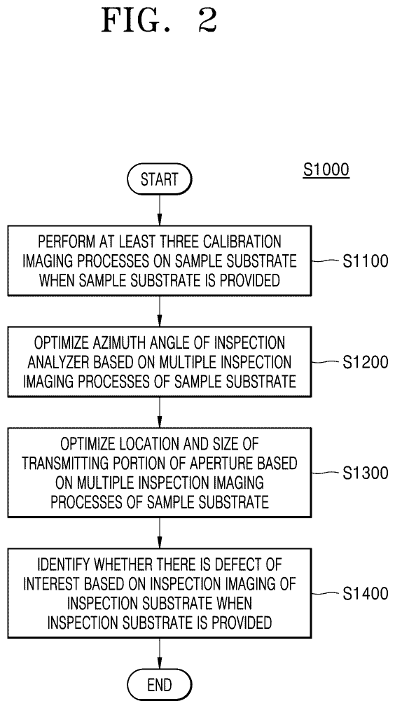

FIG. 2 is a flowchart of a method S1000 of inspecting a dark field defect, according to embodiments.

Referring to FIG. 2, when a sample substrate is provided, the dark field defect inspection system 1000 may perform at least three calibration imaging processes on the sample substrate in operation S1100. The same substrate may be arranged on the top surface of the stage 500.

In operation S1100, the at least three calibration imaging processes may be performed under different calibration-azimuth angle conditions. The controller 400 may identify (or obtain) the first ellipsometric parameter, ψ, and the second ellipsometric parameter, Δ, based on the at least three calibration imaging processes. Here, a “calibration-azimuth angle condition” may refer to a condition in which the azimuth angle P of the linear polarizer 110, the azimuth angle C of the second phase retardation plate 112, and the azimuth angle A1 of the calibration analyzer 204 are respectively set to specific values to identify the first ellipsometric parameter, and the second ellipsometric parameter, Δ.

According to embodiments, a first calibration image may be obtained by the calibration detector 202 based on calibration imaging under a first calibration-azimuth angle condition (e.g., (P, C, A1)=(0, π/4, 0)). A second calibration image may be obtained by the calibration detector 202 based on calibration imaging under a second calibration-azimuth angle condition (e.g., (P, C, A1)=(0, π/4, π/4)). A third calibration image may be obtained by the calibration detector 202 based on calibration imaging under a third calibration-azimuth angle condition (e.g., (P, C, A1)=(π/4, π/4, π/2)).

In this case, the controller 400 may identify the first ellipsometric parameter, ψ, and the second ellipsometric parameter, A, based on the first calibration image, the second calibration image, and the third calibration image. For example, when the first calibration-azimuth angle condition is (P, C, A1)=(0, π/4, 0), the second calibration-azimuth angle condition is (P, C, A1)=(0, π/4, π/4), and the third calibration-azimuth angle condition is (P, C, A1)=(π/4, π/4, π/2), the controller 400 may identify the first ellipsometric parameter, w, and the second ellipsometric parameter, Δ, based on Equation 1 and Equation 2 below.

$$tan ψ = \sqrt{I ( 0 , \frac{π}{4} , 0 ) / I ( \frac{π}{4} , \frac{π}{4} , \frac{π}{2} )} . \qquad [ Equation 1 ]$$

$$sin Δ = \frac{I ( 0 , \frac{π}{4} , 0 ) + I ( \frac{π}{4} , \frac{π}{4} , \frac{π}{2} ) - 2 I ( 0 , \frac{π}{4} , \frac{π}{4} )}{2 \sqrt{I ( 0 , \frac{π}{4} , 0 ) / I ( \frac{π}{4} , \frac{π}{4} , \frac{π}{2} )}} . \qquad [ Equation 2 ]$$

Here, I(0, π/4, 0) may be a signal intensity of a sample substrate image obtained by the calibration detector 202 under the first calibration-azimuth angle condition ((P, C, A1)=(0, π/4, 0)), I(0, π/4, π/4) may be a signal intensity of a sample substrate image obtained by the calibration detector 202 under the second calibration-azimuth angle condition ((P, C, A1)=(0, π/4, π/4)), and I(π/4, π/4, π/2) may be a signal intensity of a sample substrate image obtained by the calibration detector 202 under the third calibration-azimuth angle condition ((P, C, A1)=(π/4, π/4, π/2)).

The above-described method of identifying the first ellipsometric parameter, ψ, and the second ellipsometric parameter, Δ, is just an example. The first ellipsometric parameter, ψ, and the second ellipsometric parameter, Δ, may be identified based on calibration imaging under various calibration-azimuth angle conditions. For example, the controller 400 may identify the first ellipsometric parameter, ψ, and the second ellipsometric parameter, Δ, based on at least four calibration imaging processes.

According to embodiments, the controller 400 may identify an optimized azimuth angle, opt. P, of the linear polarizer 110 and an optimized azimuth angle, opt. A1, of the calibration analyzer 204, based on the first ellipsometric parameter, ψ, and the second ellipsometric parameter, Δ. For example, the controller 400 may calculate the optimized azimuth angle, opt. P, of the linear polarizer 110 and the optimized azimuth angle, opt. A1, of the calibration analyzer 204, based on Equation 3.

$$opt . A 1 = ψ , opt . P = \frac{Δ}{2} - \frac{π}{4} . \qquad [ Equation 3 ]$$

Here, the optimized azimuth angle, opt. P, of the linear polarizer 110 may refer to an azimuth angle of the linear polarizer 110 under the null condition, and the optimized azimuth angle, opt. A1, of the calibration analyzer 204 may refer to an azimuth angle of the calibration analyzer 204 under the null condition. In simple terms, the optimized azimuth angle, opt. P, of the linear polarizer 110 and the optimized azimuth angle, opt. A1, of the calibration analyzer 204 may be set such that surface-scattered light detected by the calibration detector 202 is extinguished. Here, the surface-scattered light may include scattered light from the rough top surface of a sample substrate. The expression “surface-scattered light detected by the calibration detector 202 is extinguished” may include a case where the intensity of surface-scattered light detected by the calibration detector 202 is 0 and a case where the intensity of surface-scattered light detected by the calibration detector 202 is very small.

According to embodiments, the controller 400 may identify (or determine) an estimated inspection angle, est. A2, of the inspection analyzer 310 based on the first ellipsometric parameter, ψ, and the oblique angle θ. The estimated inspection angle, est. A2, of the inspection analyzer 310 may refer to an azimuth angle of the inspection analyzer 310, which is identified for fine tuning of the inspection analyzer 310. For example, a fine tuning range of an inspection angle for optimization of the azimuth angle of the inspection analyzer 310 may be determined based on the estimated inspection angle, est. A2. Specifically, the estimated inspection angle, est. A2, of the inspection analyzer 310 may be calculated based on Equation 4.

$$est . A 2 = {tan}^{- 1} ( tan ψ / cos θ ) . \qquad [ Equation 4 ]$$

As described above, the dark field defect inspection system 1000 may identify the optimized azimuth angle, opt. P, of the linear polarizer 110, the optimized azimuth angle, opt. A1, of the calibration analyzer 204, and the estimated inspection angle, est. A2, of the inspection analyzer 310, based on at least three calibration imaging processes on the sample substrate in operation S1100.

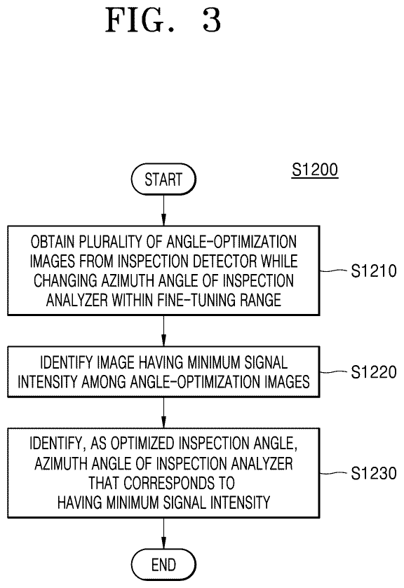

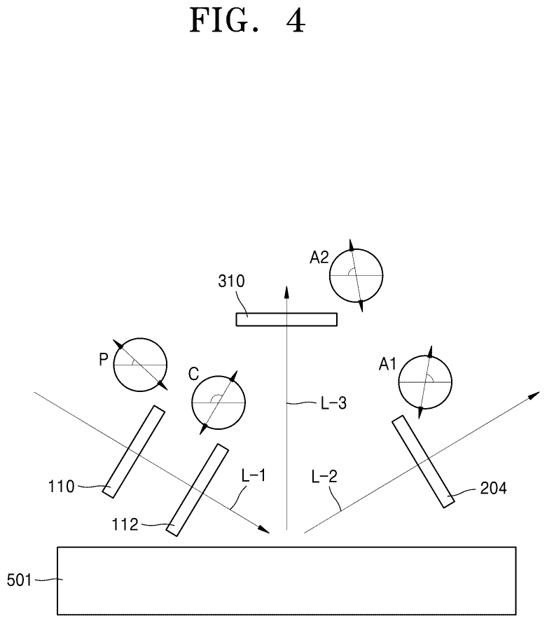

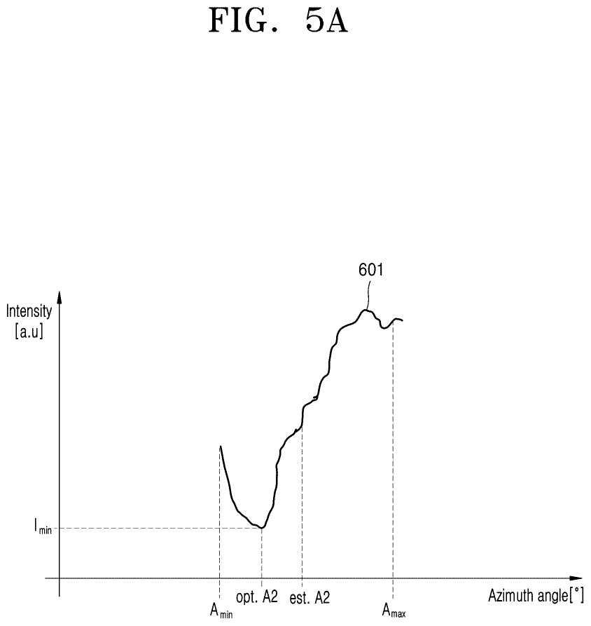

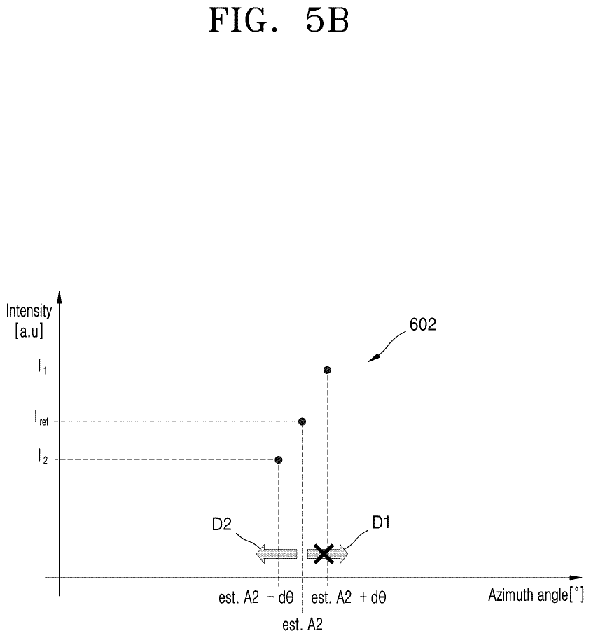

Subsequently, the dark field defect inspection system 1000 may operate in an inspection angle optimization mode in operation S1200. Specifically, in operation S1200, the dark field defect inspection system 1000 may optimize the azimuth angle of the inspection analyzer 310 based on multiple inspection imaging processes of the sample substrate. In other words, in operation S1200, an optimized inspection angle, opt. A2, of the inspection analyzer 310 may be identified. Operation S1200 is described in detail with reference to FIG. 3, FIG. 4, FIG. 5A, and FIG. 5B below.

Subsequently, the dark field defect inspection system 1000 may operate in an aperture optimization mode. Specifically, in operation S1300, the dark field defect inspection system 1000 may optimize the location and the size of the transmitting portion of the aperture 306 based on the multiple inspection imaging processes of the sample substrate. In other words, in operation S1300, the optimized location and size of the transmitting portion of the aperture 306 may be identified. Operation S1300 is described in detail with reference to FIG. 6, FIG. 7A, FIG. 7B, FIG. 7C, FIG. 8, FIG. 9A, FIG. 9B, and FIG. 9C below.

Subsequently, the dark field defect inspection system 1000 may operate in a defect inspection mode in operation S1400. Specifically, when the inspection substrate 501 is provided, the dark field defect inspection system 1000 may identify whether there is a defect of interest based on inspection imaging of the inspection substrate 501 in operation S1400. The inspection substrate 501 may be provided to the top surface of the stage 500 from above the stage 500. In operation S1400, the dark field defect inspection system 1000 may include the linear polarizer 110, the inspection analyzer 310, and the aperture 306, each of which has been set to an optimized state for detection of a defect of interest, and may obtain a dark field image, which is used to identify existence or non-existence of a defect of interest in the top surface of the inspection substrate 501, through the inspection detector 302. As the dark field defect inspection system 1000 includes the linear polarizer 110, the inspection analyzer 310, and the aperture 306, each being set to an optimized state, the dark field defect inspection system 1000 may obtain a dark field image with a high SNR.

Here, the sample substrate may be used to obtain optimized conditions of the dark field defect inspection system 1000, and the type, size, and location of a defect in the top surface of the sample substrate may be given in advance. Here, the expression “the type, size, and location of a defect in the top surface of the sample substrate are given in advance” may refer to a case where information on the type, size, and location of a defect in the top surface of the sample substrate is stored in the dark field defect inspection system 1000 and is known to a user of the dark field defect inspection system 1000 before the dark field defect inspection system 1000 performs calibration imaging or inspection imaging on the sample substrate. To obtain the information on the type, size, and location of a defect in the top surface of the sample substrate, inspection may be performed based on an external device (not shown) in advance. For example, the external device may be a scanning electron microscope (SEM), and the information on the type, size, and location of a defect in the sample substrate may be obtained through an SEM image of the sample substrate. However, the obtaining of the information on the type, size, and location of a defect in the sample substrate based on an SEM is just an example. The information on the type, size, and location of a defect in the sample substrate may be obtained based on an atomic force microscope (AFM) image, a transmission electron microscope (TEM) image, or the like.

The sample substrate may have the same structure as the inspection substrate 501. For example, when the inspection substrate 501 is a wafer including a silicon substrate and an oxide layer on the silicon substrate, the sample substrate may also include a silicon substrate and an oxide layer on the silicon substrate. In other words, the sample substrate may include a wafer manufactured based on the same semiconductor manufacturing processes as the inspection substrate 501.

The dark field defect inspection system 1000 may include the aperture 306 and the inspection analyzer 310, which are optimized such that defect-scattered light from a specific defect in the top surface of the sample substrate is detected with high signal intensity by the inspection detector 302. As described above, when the inspection substrate 501 having the same structure as the sample substrate is provided, the dark field defect inspection system 1000 may detect the same defect with high signal intensity.

FIG. 3 is a flowchart of a method, i.e., operation S1200, of optimizing the inspection analyzer 310, according to embodiments.

Referring to FIG. 3, the dark field defect inspection system 1000 may change the azimuth angle of the inspection analyzer 310 within the fine tuning range and obtain a plurality of angle-optimization images from the inspection detector 302 in operation S1210.

According to embodiments, the controller 400 may control the inspection analyzer 310 or a rotary device coupled to the inspection analyzer 310 such that the azimuth angle of the inspection analyzer 310 is changed within the fine tuning range. Here, the fine tuning range may be determined to identify the optimized inspection angle, opt. A2, of the inspection analyzer 310 based on the estimated inspection angle, est. A2.

The fine tuning range may be between an angle obtained by subtracting a fine tuning value from the estimated inspection angle, est. A2, and an angle obtained by adding the fine tuning value to the estimated inspection angle, est. A2. Here, the fine tuning value may be arbitrarily set by a user of the dark field defect inspection system 1000. For example, the fine tuning value may be 5 degrees (i.e., 5°) or less. When the fine tuning value is 5 degrees, the fine tuning range may be from a value obtained by subtracting 5 degrees from the estimated inspection angle, est. A2, to a value obtained by adding 5 degrees to the estimated inspection angle, est. A2.

The controller 400 may obtain a plurality of angle-optimization images from the inspection detector 302 while the azimuth angle of the inspection analyzer 310 is being changed within the fine tuning range. The angle-optimization images may include first to n-th angle-optimization images (where “n” is a natural number of at least 2). Each of the first to n-th angle-optimization images may be obtained from the inspection detector 302 based on inspection imaging of the sample substrate. Here, the first angle-optimization image may correspond to an inspection image when the azimuth angle of the inspection analyzer 310 is a first angle, and the second to n-th angle-optimization images may respectively correspond to inspection images when the azimuth angle of the inspection analyzer 310 is second to n-th angles.

Subsequently, the dark field defect inspection system 1000 may identify an image having a minimum signal intensity among the angle-optimization images in operation S1220. According to embodiments, the controller 400 may compare the respective signal intensities of the angle-optimization images with each other and may identify the image having the minimum signal intensity. Here, the image having the minimum signal intensity may correspond to an inspection image under the null condition.

Subsequently, the dark field defect inspection system 1000 may identify the azimuth angle of the inspection analyzer 310, which corresponds to the image having the minimum signal intensity, as the optimized inspection angle, opt. A2, in operation S1230. According to embodiments, when the first angle-optimization image is identified as the image having the minimum signal intensity, the controller 400 may identify the first angle as the optimized inspection angle, opt. A2. The controller 400 may control the inspection analyzer 310 or the rotary device coupled to the inspection analyzer 310 such that the azimuth angle of the inspection analyzer 310 is changed to the optimized inspection angle, opt. A2.

As described above, operations S1210, S1220, and S1230 included in the optimization method, i.e., operation S1200, may be performed in a state in which the aperture 306 is spaced apart from the vertical axis oa-3. In other words, while operations S1210, S1220, and S1230 are being performed, the aperture 306 may be arranged so as not to affect the propagation of the inspection light L-3.

FIG. 4 is a cross-sectional view illustrating an azimuth angle of the inspection analyzer 310, according to embodiments.

Referring to FIG. 4, the incident light L-1 may be transmitted through the linear polarizer 110 and the second phase retardation plate 112 and radiated to the top surface of the inspection substrate 501. Under the null condition, surface-scattered light in the calibration light L-2 may be blocked by the calibration analyzer 204. Under the optimized condition of the inspection analyzer 310, surface-scattered light in the inspection light L-3 may be blocked by the inspection analyzer 310.

The azimuth angle of the linear polarizer 110 may be denoted by P, and the azimuth angle of the second phase retardation plate 112 may be denoted by C. The azimuth angle of the calibration analyzer 204 may be denoted by A1, and the azimuth angle of the inspection analyzer 310 may be denoted by A2. The azimuth angles P, C, A1, and A₂ may each be an angle with respect to any direction included in the plane of incidence. Here, the plane of incidence may be one plane including all of the rays of the incident light L-1, the rays of the calibration light L-2, and the rays of the inspection light L-3.

FIG. 5A is a graph illustrating a method of optimizing the inspection analyzer 310, according to embodiments.

Referring to FIG. 5A, a graph 601 shows a change in the signal intensity of an inspection image with respect to a change in the azimuth angle of the inspection analyzer 310. According to the graph 601, the azimuth angle of the inspection analyzer 310 may change within the fine tuning range, and the signal intensity of an inspection image obtained from the inspection detector 302 may vary with the change in the azimuth angle of the inspection analyzer 310.

The fine tuning range may be between a minimum value Aₘᵢₙ and a maximum value Aₘₐₓ.

Here, the minimum value Aₘᵢₙ may be obtained by subtracting the fine tuning value from the estimated inspection angle, est. A2, and the maximum value Aₘₐₓ may be obtained by adding the fine tuning value to the estimated inspection angle, est. A2. For example, when the fine tuning value is 5 degrees, the minimum value Aₘᵢₙ may be “est. A2-5”, and the maximum value Aₘₐₓ may be “est. A2+5”.

According to embodiments, the controller 400 may identify an image having a minimum signal intensity Imin among a plurality of angle-optimization images and may identify an azimuth angle corresponding to the image having the minimum signal intensity Imin as the optimized inspection angle, opt. A2.

According to embodiments, when the minimum point of the change in the signal intensity of an inspection image is identified, the controller 400 may identify the azimuth angle of the inspection analyzer 310, which corresponds to the minimum point, as the optimized inspection angle, opt. A2. In this case, when the minimum point is identified, the controller 400 may terminate the optimization of the inspection analyzer 310 without rotating the inspection analyzer 310 any further. Accordingly, the controller 400 may quickly identify the optimized inspection angle, opt. A2, without obtaining an inspection image with respect to every azimuth angle included in the fine tuning range.

FIG. 5B is a graph illustrating a method of optimizing the inspection analyzer 310, according to embodiments.

Referring to FIG. 5B, a graph 602 shows a change in the signal intensity of an inspection image with respect to a change in the azimuth angle of the inspection analyzer 310. According to the graph 602, when the azimuth angle of the inspection analyzer 310 is the estimated inspection angle, est. A2, the signal intensity of a reference image obtained from the inspection detector 302 may be a reference signal intensity I_{ref}.

According to embodiments, the controller 400 may determine (or identify) a fine tuning direction of an inspection angle, based on the reference signal intensity I_{ref}. Specifically, the controller 400 may change the azimuth angle of the inspection analyzer 310 by a minute change angle de from the estimated inspection angle, est. A2, may obtain an inspection image in a state in which the azimuth angle has been changed by the minute change angle de from the estimated inspection angle, est. A2, and may obtain the signal intensity of the inspection image. The controller 400 may compare the signal intensity of the inspection image with the reference signal intensity I_{ref} and may determine the fine tuning direction based on a result of the comparison. The minute change angle de may be set to any angle by a user. For example, the minute change angle dθ may be 1 degree or less.

Specifically, as shown in FIG. 5B, the controller 400 may increase the azimuth angle of the inspection analyzer 310 by the minute change angle de from the estimated inspection angle, est. A2, and may obtain a first image from the inspection detector 302 in a state in which the azimuth angle of the inspection analyzer 310 has been increased by the minute change angle de from the estimated inspection angle, est. A2. The controller 400 may compare a signal intensity I₁ of the first image with the reference signal intensity I_{ref}. When the reference signal intensity I_{ref} is less than the signal intensity I₁ of the first image, the controller 400 may determine, as the fine tuning direction, a direction (e.g., a second direction D2) which is for decreasing the azimuth angle and is opposite to a direction (e.g., a first direction D1) for increasing the azimuth angle. Otherwise, when the reference signal intensity I_{ref} is equal to or greater than the signal intensity I₁ of the first image, the controller 400 may determine the direction (e.g., the first direction D1) for increasing the azimuth angle as the fine tuning direction.

According to embodiments, when the fine tuning direction is determined, the controller 400 may change the azimuth angle of the inspection analyzer 310 only in the fine tuning direction and may obtain a plurality of angle-optimization images. It is also possible that the fine tuning direction may be determined by comparing the signal intensity I₂ of a second image with the reference signal intensity I_{ref}. The second image may be obtained from the inspection detector 302 in a state in which the azimuth angle of the inspection analyzer 310 has been decreased by the minute change angle de from the estimated inspection angle, est. A2. The method of identifying the optimized inspection angle, opt. A2, based on a plurality of angle-optimization images has been described in detail with reference to FIG. 5A, and thus, detailed descriptions thereof are omitted.

As described above, the dark field defect inspection system 1000 may quickly determine the fine tuning direction based on the reference signal intensity I_{ref} at the estimated inspection angle, est. A2, and thus quickly identify the optimized inspection angle, opt. A2.

Although only the method, by which the dark field defect inspection system 1000 identifies the optimized inspection angle, opt. A2, based on inspection imaging of a sample substrate arranged on the top surface of the stage 500, has been described with reference to FIG. 3, FIG. 4, FIG. 5A, and FIG. 5B, this is just an example. The dark field defect inspection system 1000 may identify the optimized inspection angle, opt. A2, by using a method that is similar to or the same as the method described with reference to FIG. 3, FIG. 4, FIG. 5A, and FIG. 5B, based on inspection imaging of the inspection substrate 501 arranged on the top surface of the stage 500.

FIG. 6 is a flowchart of a method S1300 of optimizing the aperture 306, according to embodiments.

Referring to FIG. 6, the dark field defect inspection system 1000 may change the location and/or the size of the transmitting portion of the aperture 306 in the second exit pupil plane ep2 and obtain a plurality of aperture-optimization images from the inspection detector 302 in operation S1310.

According to embodiments, the aperture 306 may include an adjustable aperture capable of changing the size of the transmitting portion. In this case, the controller 400 may control the aperture 306 to change the size of the transmitting portion of the aperture 306. In some embodiments, the aperture 306 may include an adjustable aperture capable of changing the size and the shape of the transmitting portion. In this case, the shape of the transmitting portion may be changed to various shapes, such as a circular shape, a rectangular shape, and a bowtie shape.

In some embodiments, the adjustable aperture may be implemented by a programmable aperture. In this case, the aperture 306 may change the shape and the location of the transmitting portion according to a control signal of the controller 400. The aperture 306 may include a plurality of pixels. According to the control signal of the controller 400, some of the pixels may function as transmitting pixels, and the other pixels may function as shielding pixels. Specifically, the controller 400 may transmit, to the aperture 306, a control signal for setting first to 100th pixels as transmitting pixels and setting 101st to n-th pixels as shielding pixels (where “n” is a natural number greater than 101). Based on the control signal, the aperture 306 may set the first to 100th pixels as the transmitting pixels and the 101st to n-th pixels as the shielding pixels. In this case, the first to 100th pixels may function as the transmitting portion of the aperture 306 to transmit the inspection light L-3, and the 101st to n-th pixels may function as the shielding portion of the aperture 306 to block the inspection light L-3. According to embodiments, the aperture 306 may be connected to an aperture driving unit capable of changing the location of the aperture 306 in the second exit pupil plane ep2. In this case, the controller 400 may control the aperture driving unit to change the location of the aperture 306. According to the operation of the aperture driving unit, the location of the transmitting portion of the aperture 306 may be changed. In some embodiments, the aperture driving unit may drive the aperture 306 not only within the second exit pupil plane ep2 but also along the vertical optical axis oa-3.

Subsequently, the dark field defect inspection system 1000 may identify a maximum-SNR image among the aperture-optimization images in operation S1320. Subsequently, the dark field defect inspection system 1000 may identify the location and/or the size of the transmitting portion corresponding to the maximum-SNR image as the optimized location and/or the optimized size of the transmitting portion.

Here, the aperture-optimization images may refer to a plurality of inspection images obtained from the inspection detector 302 while the location and/or the size of the transmitting portion of the aperture 306 is being changed. In some embodiments, a plurality of aperture-optimization images may include a plurality of location-optimization images and a plurality of size-optimization images. The location-optimization images may be obtained to optimize the location of the transmitting portion, and the size-optimization images may be obtained to optimize the size of the transmitting portion. This is described in detail in the description of the drawings below.

Here, SNR is a signal-to-noise ratio. The SNR of an inspection image obtained from the inspection detector 302 may be a ratio of a signal intensity corresponding to a defect of interest to the signal intensity of noise. Specifically, noise in the inspection image may correspond to surface-scattered light. As described above with reference to FIG. 1, the inspection analyzer 310 and the aperture 306 may not completely block surface-scattered light, and part of the surface-scattered light may pass through the inspection analyzer 310 and the aperture 306 and may be detected by the inspection detector 302 and may be identified as noise. Here, because the type, location, and size of a defect of interest in the top surface of a sample substrate are given, the controller 400 may distinguish a signal corresponding to the defect of interest from noise in the inspection image obtained from the inspection detector 302 and may quickly calculate an SNR of the inspection image based on a result of the distinguishment.

Operations S1310, S1320, and S1330 included in the method S1300 described above may be performed in a state in which the sample substrate is arranged on the top surface of the stage 500 and the azimuth angle of the inspection analyzer 310 is set to the optimized inspection angle, opt. A2. In other words, the aperture 306 may be optimized in a state in which the inspection analyzer 310 is optimized.

FIG. 7A is a plan view of the aperture 306 according to embodiments.

Referring to FIG. 7A, the aperture 306 may include a transmitting portion 306tp and a shielding portion 306sp. The aperture 306 may be coupled to an aperture driving unit 510. The aperture driving unit 510 may include a first direction driver 511 and a second direction driver 512.

According to embodiments, as shown in FIG. 7A, the transmitting portion 306tp may correspond to a pin hole composed of an air layer. The shielding portion 306sp may surround the transmitting portion 306tp. The shielding portion 306sp may include a light-absorbing material layer, which may include various light-absorbing materials, such as chrome, tungsten, and molybdenum. In some embodiments, the transmitting portion 306tp may include a light-transmitting material layer, which may include various light-transmitting materials, such as glass and quartz.

According to embodiments, the aperture 306 may correspond to an adjustable aperture so that the size of the transmitting portion 306tp may be adjusted. For example, the controller 400 may control the size of the transmitting portion 306tp by adjusting the diameter of the transmitting portion 306tp. Although FIG. 7A illustrates that the transmitting portion 306tp may have a circular shape, this is just an example. The transmitting portion 306tp may have various shapes, such as a rectangular shape and a pentagonal shape.

The first direction driver 511 and the second direction driver 512 may be arranged in the second exit pupil plane ep2 and coupled to the aperture 306. The first direction driver 511 may drive the aperture 306 in a first direction, and the second direction driver 512 may drive the aperture 306 in a second direction. Accordingly, the location of the transmitting portion 306tp in the second exit pupil plane ep2 may be changed in the first direction and/or the second direction. The first direction and the second direction may be perpendicular to each other and may both be parallel with the second exit pupil plane ep2.

Although FIG. 7A illustrates that the aperture driving unit 510 may drive the aperture 306 on the second exit pupil plane ep2, this is just an example. The aperture driving unit 510 may further include a third direction driver (not shown), which may drive the aperture 306 along the vertical optical axis oa-3.

FIG. 7B is a plan view of the aperture 306 according to embodiments.

Referring to FIG. 7B, a center ce2 of the transmitting portion 306tp of the aperture 306 may be spaced apart from a center ce1 of the second exit pupil plane ep2.

According to embodiments, a diameter tpd of the transmitting portion 306tp may be less than an exit pupil diameter EPD. The exit pupil diameter EPD may refer to the diameter of a light-incident region of the second exit pupil plane ep2. For example, that the exit pupil diameter EPD is 8 mm may mean that the diameter of an incident region of the inspection light L-3 in the second exit pupil plane ep2 is 8 mm. An exit pupil radius may refer to half of the exit pupil diameter EPD. The center ce1 of the second exit pupil plane ep2 may refer to the center of the incident region of the inspection light L-3 in the second exit pupil plane ep2.

As described with reference to FIG. 7A, the location of the center ce2 of the transmitting portion 306tp may be changed by the aperture driving unit 510. The size (e.g., the diameter tpd) of the transmitting portion 306tp may also be changed.

According to embodiments, the controller 400 may control the aperture driving unit 510 such that the location of the transmitting portion 306tp is scanned along the second exit pupil plane ep2. In this case, the controller 400 may change the location of the transmitting portion 306tp within a region that prevents the transmitting portion 306tp from leaving the light-incident region of the second exit pupil plane ep2.

While the location of the transmitting portion 306tp is being scanned along the second exit pupil plane ep2, the controller 400 may obtain a plurality of location-optimization images from the inspection detector 302. The location-optimization images may include first to n-th location-optimization images, where “n” is a natural number of at least 2. Each of the first to n-th location-optimization images may be obtained from the inspection detector 302 based on inspection imaging of a sample substrate. The first location-optimization image may correspond to an inspection image obtained when the location of the transmitting portion 306tp is a first location, and the second to n-th location-optimization images may respectively correspond to inspection images respectively obtained when the locations of the transmitting portion 306tp are second to n-th locations.

The controller 400 may identify an image having a maximum SNR among the first to n-th location-optimization images and may identify the location of the transmitting portion 306tp, which corresponds to the image having the maximum SNR, as an optimized location. For example, when the first location-optimization image among the first to n-th location-optimization images is the image having the maximum SNR, the controller 400 may identify the first location as the optimized location of the transmitting portion 306tp.

According to embodiments, the controller 400 may control the aperture 306 such that the size of the transmitting portion 306tp is changed. In this case, the controller 400 may change the size of the transmitting portion 306tp within a range that prevents the size of the transmitting portion 306tp from being greater than the light-incident region of the second exit pupil plane ep2.

While the size of the transmitting portion 306tp is being changed, the controller 400 may obtain a plurality of size-optimization images from the inspection detector 302. The size-optimization images may include first to n-th size-optimization images, where “n” is a natural number of at least 2. Each of the first to n-th size-optimization images may be obtained from the inspection detector 302 based on inspection imaging of a sample substrate. The first size-optimization image may correspond to an inspection image obtained when the size of the transmitting portion 306tp is a first size, and the second to n-th size-optimization images may respectively correspond to inspection images respectively obtained when the sizes of the transmitting portion 306tp are second to n-th sizes.

The controller 400 may identify an image having a maximum SNR among the first to n-th size-optimization images and may identify the size of the transmitting portion 306tp, which corresponds to the image having the maximum SNR, as an optimized size. For example, when the first size-optimization image among the first to n-th size-optimization images is the image having the maximum SNR, the controller 400 may identify the first size as the optimized size of the transmitting portion 306tp.

Although embodiments in which the controller 400 changes the location of the transmitting portion 306tp and embodiments in which the controller 400 changes the size of the transmitting portion 306tp are separately described, the controller 400 may obtain a plurality of aperture-optimization images while changing both the location and the size of the transmitting portion 306tp.

FIG. 7C is a table illustrating a method of optimizing the transmitting portion 306tp of the aperture 306, according to embodiments. Referring to FIG. 7C, the controller 400 may obtain a plurality of aperture-optimization images and may identify an SNR corresponding to each of the aperture-optimization images.

According to embodiments, the controller 400 may obtain a plurality of aperture-optimization images from the inspection detector 302 while the location and the size of the transmitting portion 306tp are being changed. For example, the controller 400 may obtain a plurality of images of a sample substrate while changing the diameter of the transmitting portion 306tp in a state in which the transmitting portion 306tp is fixed to a specific location. As shown in FIG. 7C, the controller 400 may fix the location of the center ce2 of the transmitting portion 306tp to (0, 0), may change the diameter of the transmitting portion 306tp to D1, D2, and D3, may obtain a plurality of images Image 11, Image 12, and Image 13 of a sample substrate, and may identify an SNR of each of the images Image 11, Image 12, and Image 13. Subsequently, the controller 400 may fix the location of the center ce2 of the transmitting portion 306tp to (1, 2), may change the diameter of the transmitting portion 306tp to D1, D2, and D3, and may obtain a plurality of images Image 81, Image 82, and Image 83 of the sample substrate. The controller 400 may also identify an SNR of each of the images Image 81, Image 82, and Image 83.

The controller 400 may identify an image having a maximum SNR among the aperture-optimization images and may identify the location and the size of the transmitting portion 306tp, which correspond to the image having the maximum SNR, as optimized location and size. When the optimized location and size are identified, the controller 400 may control the aperture driving unit 510 to move the transmitting portion 306tp to the optimized location and may control the aperture 306 such that the size of the transmitting portion 306tp is changed to the optimized size. For example, as shown in FIG. 7C, when the image having the maximum SNR is an image Image 102, the controller 400 may identify a location, at which the center ce2 of the transmitting portion 306tp is located at (3, 0) in the second exit pupil plane ep2, as the optimized location of the transmitting portion 306tp and may identify the diameter D5 as the optimized size of the transmitting portion 306tp.

Although it has been described above that the controller 400 may obtain a plurality of image of a sample substrate while changing the size of the transmitting portion 306tp and fixing the center ce2 of the transmitting portion 306tp to a specific location, this is just an example. The controller 400 may obtain a plurality of image of a sample substrate while changing the location of the transmitting portion 306tp and fixing the size of the transmitting portion 306tp to a specific size.

As described above with reference to FIG. 6, FIG. 7A, FIG. 7B, and FIG. 7C, the dark field defect inspection system 1000 may obtain an optimized aperture condition based on inspection imaging processes of a sample substrate, which has the same structure as the inspection substrate 501 and includes a defect of interest. The optimized aperture condition may allow the defect of interest in the top surface of the sample substrate to be detected with a high-SNR image. Accordingly, when the inspection substrate 501 is provided on the stage 500, the dark field defect inspection system 1000 may accurately inspect whether the defect of interest is present in the top surface of the inspection substrate 501, based on the optimized aperture condition.

FIG. 8 is a cross-sectional view of a sample substrate 501s according to embodiments. Referring to FIG. 8, the sample substrate 501s may include a rough top surface rs and a protrusion-type defect de, which protrudes upward from the rough top surface rs.

The protrusion-type defect de may include any kind of defect that protrudes upward from the top surface of a substrate. For example, the protrusion-type defect de may include various kinds of defects that occur when there is a foreign particle is present in the top surface of a substrate or when process residue is not completely removed.

As shown in FIG. 8, when an optimized aperture condition is obtained based on the sample substrate 501s including the protrusion-type defect de, a defect of interest of the dark field defect inspection system 1000 may be the protrusion-type defect de. Experimental results of optimizing an aperture condition based on the sample substrate 501s are described with reference to FIGS. 9A to 9C below.

FIG. 9A is a schematic graph showing experimental results of the dark field defect inspection system 1000, according to embodiments. FIG. 9B is a schematic graph showing experimental results of the dark field defect inspection system 1000, according to embodiments. FIG. 9C is a schematic graph showing experimental results of the dark field defect inspection system 1000, according to embodiments.

The graphs of FIGS. 9A and 9B show results of an experiment in which inspection images were obtained from the inspection detector 302 while the location of the transmitting portion 306tp was being changed with respect to the sample substrate 501s including the protrusion-type defect de having a size of about 30 nm. The graph of FIG. 9C shows results of an experiment in which inspection images were obtained from the inspection detector 302 while the diameter tpd of the transmitting portion 306tp was being changed with respect to the sample substrate 501s including the protrusion-type defect de having a size of about 13 nm. In the experiments performed to obtain the graphs of FIGS. 9A to 9C, the exit pupil diameter EPD was 16 mm.

Referring to FIG. 9A, it may be seen that high-SNR images are detected at a first point p1 and a second point p2, respectively. The first point p1 indicates the SNR of an inspection image, which is obtained when the location of the center ce2 of the transmitting portion 306tp is moved from the center ce1 of the second exit pupil plane ep2 by −0.5 mm in a first direction (e.g., the x-axis direction). The second point p2 indicates the SNR of an inspection image, which is obtained when the location of the center ce2 of the transmitting portion 306tp is moved from the center ce1 of the second exit pupil plane ep2 by +0.5 mm in the first direction.

Referring to FIG. 9B, it may be seen that high-SNR images are detected at a third point p3, a fourth point p4, a fifth point p5, and a sixth point p6, respectively. The third point p3 indicates the SNR of an inspection image, which is obtained when the location of the center ce2 of the transmitting portion 306tp is moved from the center ce1 of the second exit pupil plane ep2 by −1 mm in a second direction (e.g., the y-axis direction). The fourth point p4 indicates the SNR of an inspection image, which is obtained when the location of the center ce2 of the transmitting portion 306tp is the same as the location of the center ce1 of the second exit pupil plane ep2. The fifth point p5 indicates the SNR of an inspection image, which is obtained when the location of the center ce2 of the transmitting portion 306tp is moved from the center ce1 of the second exit pupil plane ep2 by +1 mm in the second direction. The sixth point p6 indicates the SNR of an inspection image, which is obtained when the location of the center ce2 of the transmitting portion 306tp is moved from the center ce1 of the second exit pupil plane ep2 by +2 mm in the second direction.

Referring to the experimental results of FIGS. 9A and 9B, when the sample substrate 501s includes the protrusion-type defect de in the top surface thereof, it may be seen that an image having a relatively high SNR is obtained when the location of the transmitting portion 306tp is in the central portion of the second exit pupil plane ep2. It may also be seen that an image having a relatively high SNR is obtained when the location of the transmitting portion 306tp is within a quarter of the radius (e.g., 8 mm) of the second exit pupil plane ep2 from the center ce1 of the second exit pupil plane ep2.

According to the experimental results described above, when a defect of interest is the protrusion-type defect de, the controller 400 may identify the central portion of the second exit pupil plane ep2 as the optimized location of the transmitting portion 306tp and may control the aperture driving unit 510 to location the aperture driving unit 510 in the central portion of the second exit pupil plane ep2. Alternatively, when a defect of interest is the protrusion-type defect de, to identify the optimized location of the transmitting portion 306tp, the controller 400 may control the aperture driving unit 510 such that the location of the transmitting portion 306tp is scanned along a scanning region. The scanning region may be within a distance of a quarter of the radius of the second exit pupil plane ep2 from the center ce1 of the second exit pupil plane ep2. While the location of the transmitting portion 306tp is being scanned along the scanning region, the controller 400 may obtain a plurality of location-optimization images and an SNR of each of the location-optimization images. The controller 400 may quickly identify the optimized location of the transmitting portion 306tp by scanning the location of the transmitting portion 306tp along only the scanning region rather than the entire region of the second exit pupil plane ep2.

FIG. 9C shows the results of an experiment in which after the location of the center ce2 of the transmitting portion 306tp is matched with the location of the center ce1 of the second exit pupil plane ep2, inspection images are obtained from the inspection detector 302 while the diameter tpd of the transmitting portion 306tp is being changed. It may be seen that images having a relatively high SNR are obtained in a first bar b1, a second bar b2, and a third bar b3. The first bar b1 indicates the SNR of an inspection image obtained when the diameter tpd of the transmitting portion 306tp is 5 mm. The second bar b2 indicates the SNR of an inspection image obtained when the diameter tpd of the transmitting portion 306tp is 6 mm. The third bar b3 indicates the SNR of an inspection image obtained when the diameter tpd of the transmitting portion 306tp is 7 mm. In this experiment, the NA of the inspection optical system 300 was 0.5 when the diameter tpd of the transmitting portion 306tp was 5 mm and was 0.7 when the diameter tpd of the transmitting portion 306tp was 7 mm.

According to the experimental results described above, when a defect of interest is the protrusion-type defect de, the controller 400 may identify that the optimized size of the transmitting portion 306tp is between a first size and a second size. The first size may refer to the size of the transmitting portion 306tp that makes the NA of the inspection optical system 300 0.5, and the second size may refer to the size of the transmitting portion 306tp that makes the NA of the inspection optical system 300 0.7. The controller 400 may control the aperture 306 such that the size of the transmitting portion 306tp is changed between the first size and the second size and may obtain a plurality of size-optimization images of a sample substrate from the inspection detector 302 while the size of the transmitting portion 306tp is being changed between the first size and the second size. The controller 400 may obtain the SNR of each of the size-optimization images and may identify the optimized size of the transmitting portion 306tp based on the SNR of each of the size-optimization images.

As described above with reference to FIG. 6, FIG. 7A, FIG. 7B, FIG. 7C, FIG. 8, FIG. 9A, FIG. 9B, and FIG. 9C, the dark field defect inspection system 1000 may identify an aperture condition optimized to detect a defect of interest with a high-SNR image, based on multiple inspection imaging processes of the sample substrate 501s. For example, when the defect of interest is the protrusion-type defect de, surface-scattered light among scattered light incident to the second exit pupil plane ep2 may be incident to the second exit pupil plane ep2 at a large angle with respect to the vertical optical axis oa-3, whereas defect-scattered light from the protrusion-type defect de may be incident to the second exit pupil plane ep2 at a relatively small angle with respect to the vertical optical axis oa-3. Accordingly, when the transmitting portion 306tp is positioned in the central portion of the second exit pupil plane ep2, the defect-scattered light may travel toward the transmitting portion 306tp while the surface-scattered light is highly likely to travel toward the shielding portion 306sp. Accordingly, when the transmitting portion 306tp is positioned in the central portion of the second exit pupil plane ep2 and the size of the transmitting portion 306tp is appropriately set, an optimized aperture condition may be identified.

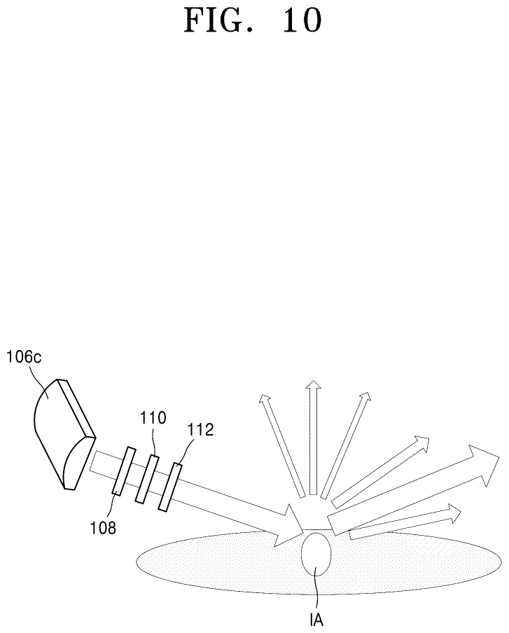

FIG. 10 is a diagram illustrating a configuration of the illumination optical system 100 according to embodiments.

Referring to FIG. 10, the illumination optical system 100 may include a cylindrical lens 106c arranged between the first phase retardation plate 108 and the light source 102 along the first oblique optical axis oa-1. The cylindrical lens 106c may collimate the incident light L-1 in a first direction that is perpendicular to the first oblique optical axis oa-1 and may transmit the incident light L-1 as is in a second direction that is perpendicular to the first oblique optical axis oa-1 and the first direction. Accordingly, an illumination region IA may have an oval shape. The illumination region IA may refer to a region of the top surface of the inspection substrate 501 to which the incident light L-1 is radiated.

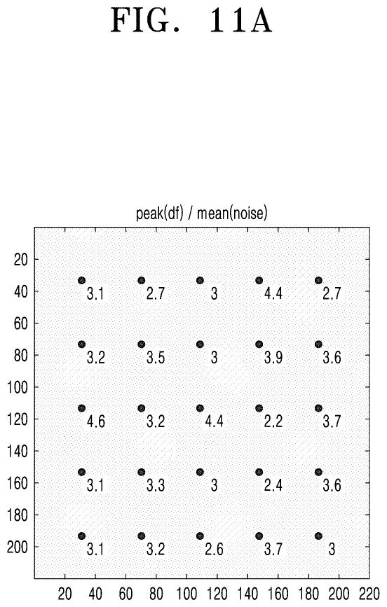

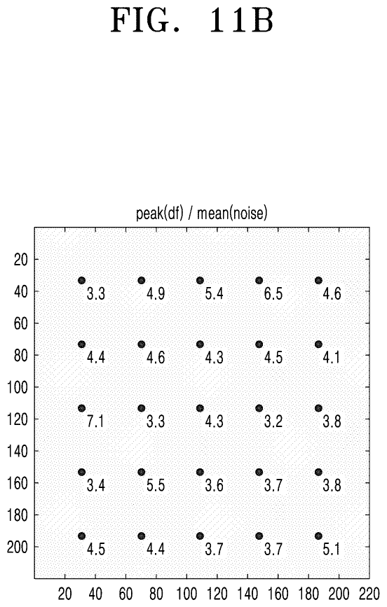

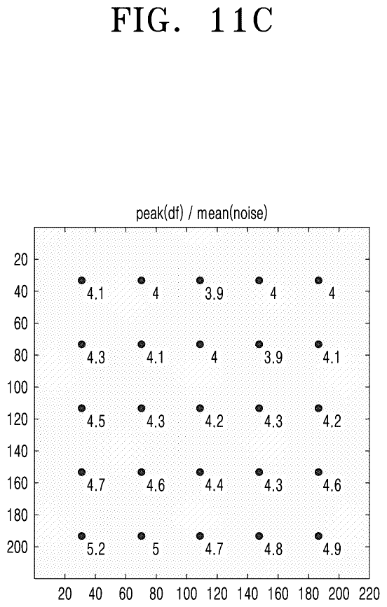

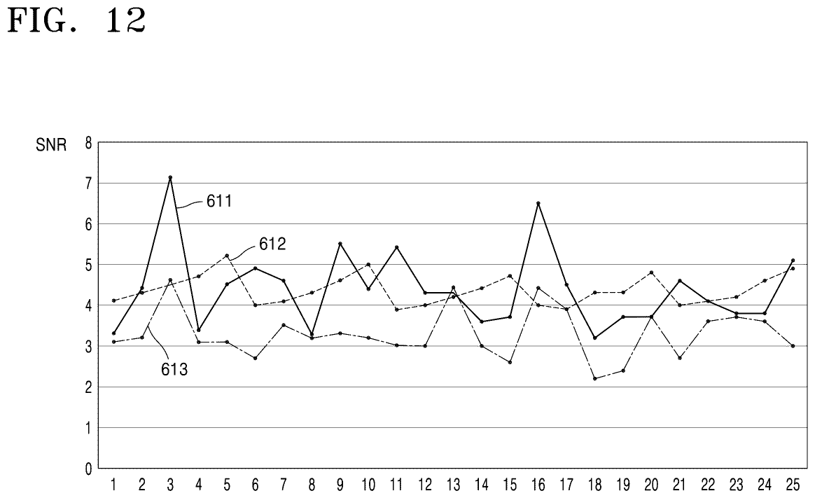

When the illumination region IA has an oval shape, the SNR of an inspection image may be increased. This is described in detail in the description of experimental results in FIG. 11A, FIG. 11B, FIG. 11C, and FIG. 12.

FIGS. 11A to 11C show defect inspection images obtained by the dark field defect inspection system 1000, according to embodiments. FIG. 12 is a schematic graph showing experimental results of the dark field defect inspection system 1000, according to embodiments.

In FIGS. 11A to 11C, the numbers displayed inside the inspection images represent peak signal-to-noise ratios. FIG. 11A shows an inspection image obtained by the inspection detector 302 when the incident light L-1 output from the illumination optical system 100 is not focused. FIG. 11B shows an inspection image obtained by the inspection detector 302 when the incident light L-1 is focused by the cylindrical lens 106c. FIG. 11C shows an inspection image obtained by the inspection detector 302 when the incident light L-1 is focused by a spherical lens.

Comparing the inspection images of FIGS. 11A to 11C with each other, it may be seen that the peak signal-to-noise ratios in FIG. 11A are the lowest. It may also be seen that the peak signal-to-noise ratios in FIGS. 11B and 11C are relatively high and that the peak signal-to-noise ratios in FIG. 11B is higher than those in FIG. 11C. In short, it may be seen that the SNR of an inspection image obtained when the incident light L-1 is focused using the cylindrical lens 106c is the highest.

In the graph of FIG. 12, the x-axis is an image index, and the y-axis is an SNR of an image. A first graph 611 shows the SNR of each of 25 images obtained when the incident light L-1 is focused using the cylindrical lens 106c. A second graph 612 shows the SNR of each of 25 images obtained when the incident light L-1 is focused using a spherical lens. A third graph 613 shows the SNR of each of 25 images obtained when the incident light L-1 is not focused.

Referring to FIG. 12, it may be seen that the first graph 611 shows a higher SNR than the second graph 612 and the third graph 613. Although the first graph 611 shows lower SNRs than the second graph 612 with respect to some images, it has been experimentally confirmed that the first graph 611 shows the highest SNR on average. Consequently, when the illumination optical system 100 includes the cylindrical lens 106c between the light source 102 and the first phase retardation plate 108, an image having a high SNR may be obtained.

While the inventive concept has been particularly shown and described with reference to embodiments thereof, it will be understood that various changes in form and details may be made therein without departing from the spirit and scope of the following claims.

What is claimed is:

1. A dark field defect inspection system comprising:
a stage on which an inspection substrate is arranged;
an illumination optical system configured to radiate incident light to a top surface of the inspection substrate and arranged along a first oblique optical axis rotated in a first rotation direction from a normal line to the top surface of the inspection substrate by an oblique angle;
a calibration optical system configured to receive calibration light and arranged along a second oblique optical axis rotated in a second rotation direction from the normal line by the oblique angle, the second rotation direction being opposite to the first rotation direction; and
an inspection optical system configured to receive inspection light and arranged along a vertical optical axis extending upward from the inspection substrate,
wherein the illumination optical system includes:
a light source configured to output the incident light;
a delivery optical system configured to shape the incident light output from the light source into a preset shape, the delivery optical system including at least one lens;
a first phase retardation plate and a second phase retardation plate each configured to delay a phase of the incident light; and
a linear polarizer arranged between the first phase retardation plate and the second phase retardation plate,
the inspection optical system includes:
an inspection detector configured to receive the inspection light;
an objective lens facing an inspection region of the inspection substrate;
a tube lens arranged before the inspection detector along the vertical optical axis;
an inspection analyzer arranged after the objective lens along the vertical optical axis; and
an aperture arranged along the vertical optical axis and arranged in an exit pupil plane of the objective lens,
the delivery optical system of the illumination optical system includes
a cylindrical lens arranged between the first phase retardation plate and the light source along the first oblique optical axis,
the exit pupil plane of the objective lens includes a virtual plane on which the inspection light exiting the objective lens converges,
the oblique angle is about 50 degrees to about 75 degrees, and
the calibration light and the inspection light include scattered light from the inspection substrate.

2. The dark field defect inspection system of claim 1, wherein:
the aperture includes a transmitting portion and a shielding portion surrounding the transmitting portion,
the transmitting portion is arranged in an optimized location on the exit pupil plane of the objective lens,
the optimized location is determined based on a signal-to-noise ratio (SNR) of each of a plurality of location-optimization images of a sample substrate,
the plurality of location-optimization images include images of the sample substrate that are obtained by the inspection detector while a location of the transmitting portion is being scanned along the exit pupil plane of the objective lens, and
the sample substrate includes a defect of interest in a top surface of the sample substrate.

3. The dark field defect inspection system of claim 2, wherein:
an optimized size of the transmitting portion is determined based on an optimized numerical aperture of the inspection optical system,
the optimized numerical aperture is determined based on an SNR of each of a plurality of size-optimization images, and
the plurality of size-optimization images include images of the sample substrate that are obtained by the inspection detector while a size of the transmitting portion is being changed in the exit pupil plane of the objective lens.

4. The dark field defect inspection system of claim 1, wherein:
a defect of interest of the inspection optical system includes a protrusion-type defect that protrudes upward from a top surface of a substrate,
the aperture includes a transmitting portion and a shielding portion surrounding the transmitting portion, and
an optimized size of the transmitting portion allows a numerical aperture of the inspection optical system to be set to about 0.5 to about 0.7.

5. The dark field defect inspection system of claim 4, wherein the transmitting portion is positioned in a central portion of the exit pupil plane of the objective lens.

6. The dark field defect inspection system of claim 1, wherein:
an azimuth angle of the inspection analyzer corresponds to an optimized inspection angle,
the optimized inspection angle is determined based on a signal intensity of each of a plurality of angle-optimization images of a sample substrate,
the plurality of angle-optimization images include images of the sample substrate that are obtained by the inspection detector while the azimuth angle of the inspection analyzer is being changed within a fine tuning range,
the fine tuning range is determined based on an estimated inspection angle,
the estimated inspection angle is determined based on an ellipsometric parameter and the oblique angle, and
the ellipsometric parameter is identified based on at least three calibration imaging processes through the calibration optical system.

7. The dark field defect inspection system of claim 6, wherein:
the optimized inspection angle corresponds to the azimuth angle of the inspection analyzer, wherein the azimuth angle of the inspection analyzer corresponds to an image having a minimum signal intensity among the plurality of angle-optimization images, and
the fine tuning range is between an angle obtained by subtracting 5 degrees from the estimated inspection angle and an angle obtained by adding 5 degrees to the estimated inspection angle.

8. The dark field defect inspection system of claim 1, wherein the aperture includes an adjustable aperture.

9. The dark field defect inspection system of claim 1, wherein
the inspection optical system further includes:
a magnification adjustment device configured to drive the tube lens along the vertical optical axis, and
a magnification of the inspection optical system is about 50 times to about 300 times.

10. A dark field defect inspection system comprising:
a stage;
an illumination optical system configured to radiate incident light to a top surface of an inspection substrate along a first oblique optical axis rotated in a first rotation direction from a normal line to the top surface of the inspection substrate by an oblique angle;
a calibration optical system configured to receive calibration light traveling along a second oblique optical axis rotated in a second rotation direction from the normal line by the oblique angle, the second rotation direction being opposite to the first rotation direction; and
an inspection optical system configured to receive inspection light traveling along a vertical optical axis extending upward from the inspection substrate,
wherein the illumination optical system includes:
a light source configured to output the incident light;
a half-wave plate arranged after the light source along the first oblique optical axis;
a linear polarizer arranged after the half-wave plate along the first oblique optical axis; and
a quarter-wave plate arranged after the linear polarizer along the first oblique optical axis, the inspection optical system includes:
an inspection detector configured to receive the inspection light;
an objective lens facing an inspection region of the inspection substrate;
a tube lens arranged before the inspection detector along the vertical optical axis;
an inspection analyzer arranged along the vertical optical axis and arranged in a first exit pupil plane of the objective lens; and
an aperture arranged along the vertical optical axis and arranged in a second exit pupil plane of the objective lens, and
the first exit pupil plane and the second exit pupil plane each include a virtual plane on which the inspection light exiting the objective lens converges.

11. The dark field defect inspection system of claim 10, further comprising
a controller,
wherein the inspection optical system further includes a rotary device configured to change an azimuth angle of the inspection analyzer,
in an inspection angle optimization mode, the controller is configured to:
when a sample substrate is arranged on a top surface of the stage, control the rotary device such that the azimuth angle of the inspection analyzer is changed within a fine tuning range;
obtain, from the inspection detector, a plurality of angle-optimization images respectively corresponding to a plurality of azimuth angles of the inspection analyzer;
identify an image having a minimum signal intensity among the plurality of angle-optimization images and identify, as an optimized inspection angle, the azimuth angle of the inspection analyzer that corresponds to the image having the minimum signal intensity; and
control the rotary device such that the azimuth angle of the inspection analyzer is changed to the optimized inspection angle,
the fine tuning range is determined based on an estimated inspection angle,
the estimated inspection angle is determined based on an ellipsometric parameter and the oblique angle, and
the ellipsometric parameter is identified based on at least three calibration imaging processes through the calibration optical system.

12. The dark field defect inspection system of claim 11, wherein,
in the inspection angle optimization mode, the controller is further configured to:
control the rotary device such that the azimuth angle of the inspection analyzer is set to the estimated inspection angle;
obtain, from the inspection detector, a reference image of the sample substrate at the estimated inspection angle;
obtain a first image of the sample substrate from the inspection detector while controlling the rotary device such that the azimuth angle of the inspection analyzer is rotated in a first direction from the estimated inspection angle by a minute change angle;
when a signal intensity of the reference image is less than a signal intensity of the first image, obtain the plurality of angle-optimization images while changing the azimuth angle of the inspection analyzer in a second direction opposite to the first direction; and
when the signal intensity of the reference image is equal to or greater than the signal intensity of the first image, obtain the plurality of angle-optimization images while changing the azimuth angle of the inspection analyzer in the first direction.

13. The dark field defect inspection system of claim 12, wherein,
in the inspection angle optimization mode, the controller is further configured to:
calculate a signal intensity of each of the plurality of angle-optimization images while obtaining the plurality of angle-optimization images;
control the rotary device to stop changing the azimuth angle of the inspection analyzer when a minimum point of a change in a signal intensity of each of the plurality of angle-optimization images id identified; and
identify, as the optimized inspection angle, the azimuth angle of the inspection analyzer that corresponds to the minimum point.

14. The dark field defect inspection system of claim 10, further comprising:
a controller; and
an aperture driving unit configured to change a location of an adjustable aperture in the second exit pupil plane,
wherein the aperture includes the adjustable aperture,
the adjustable aperture includes a transmitting portion and a shielding portion surrounding the transmitting portion, and
in an aperture-optimization mode, the controller is configured to:
when a sample substrate is arranged on a top surface of the stage, control the aperture driving unit such that a location of the transmitting portion is scanned along the second exit pupil plane;
obtain, from the inspection detector, a plurality of location-optimization images respectively corresponding to a plurality of locations of the transmitting portion;
identify an image having a maximum signal-to-noise ratio (SNR) among the plurality of location-optimization images and identify, as an optimized location, the location of the transmitting portion that corresponds to the image having the maximum SNR; and
control the aperture driving unit to position the transmitting portion at the optimized location.

15. The dark field defect inspection system of claim 14, wherein,
in the aperture-optimization mode, the controller is further configured to:
control the adjustable aperture to change a size of the transmitting portion when the sample substrate is arranged on the stage;
obtain, from the inspection detector, a plurality of size-optimization images respectively corresponding to a plurality of sizes of the transmitting portion;
identify an image having a maximum SNR among the plurality of size-optimization images and identify, as an optimized size, the size of the transmitting portion that corresponds to the image having the maximum SNR; and
control the adjustable aperture such that the transmitting portion has the optimized size.

16. The dark field defect inspection system of claim 14, wherein:
a defect of interest of the inspection optical system includes a protrusion-type defect that protrudes upward from a top surface of a substrate,
the sample substrate includes the protrusion-type defect,
in the aperture-optimization mode, the controller is further configured to
control the aperture driving unit such that a location of the transmitting portion is scanned along a scanning region of the second exit pupil plane when the sample substrate is arranged on the stage, and
the scanning region is within a quarter of a radius of the second exit pupil plane from a center of the second exit pupil plane.

17. The dark field defect inspection system of claim 16, wherein:
in the aperture-optimization mode, the controller is further configured to
control the adjustable aperture to change a size of the transmitting portion between a first size and a second size when the sample substrate is arranged on the stage,
the first size is the size of the transmitting portion that allows a numerical aperture of the inspection optical system to be 0.5, and
the second size is the size of the transmitting portion that allows the numerical aperture of the inspection optical system to be 0.7.

18. The dark field defect inspection system of claim 10, wherein:
the inspection optical system further includes a magnification adjustment device configured to change a location of the tube lens along the vertical optical axis, and
a magnification of the inspection optical system is about 50 times to about 300 times.

19. A dark field defect inspection system comprising:
a stage on which an inspection substrate is arranged;
an illumination optical system configured to radiate incident light to a top surface of the inspection substrate along a first oblique optical axis rotated in a first rotation direction from a normal line to the top surface of the inspection substrate by an oblique angle;
a calibration optical system configured to receive calibration light traveling along a second oblique optical axis rotated in a second rotation direction from the normal line by the oblique angle, the second rotation direction being opposite to the first rotation direction; and
an inspection optical system configured to receive inspection light traveling along a vertical optical axis from the inspection substrate,
wherein the illumination optical system includes:
a light source configured to output the incident light;
a first phase retardation plate and a second phase retardation plate each arranged along the first oblique optical axis and configured to delay a phase of the incident light; and
a linear polarizer arranged between the first phase retardation plate and the second phase retardation plate along the first oblique optical axis,
the inspection optical system includes:
an inspection detector configured to receive the inspection light;
an objective lens arranged along the vertical optical axis and facing an inspection region of the inspection substrate;
a tube lens arranged before the inspection detector along the vertical optical axis;
a first relay lens and a second relay lens arranged between the objective lens and the tube lens along the vertical optical axis;
an inspection analyzer arranged between the first relay lens and the second relay lens along the vertical optical axis; and
an aperture arranged before the tube lens along the vertical optical axis,
the inspection analyzer is arranged in a rear focal plane of the first relay lens and a front focal plane of the second relay lens,
the aperture is arranged in a rear focal plane of the second relay lens and a front focal plane of the tube lens,
the oblique angle is about 50 degrees to about 75 degrees, and
the calibration light and the inspection light include scattered light from the inspection substrate.

20. The dark field defect inspection system of claim 19, wherein
the calibration optical system includes:
a calibration detector configured to receive the calibration light; and
a calibration analyzer arranged before the calibration detector along the second oblique optical axis.
